(19) United States
(12) Patent Application Publication
(10) Pub. No.: US 2024/0095890 A1
(43) Pub. Date: Mar. 21, 2024

(54) A METHOD AND APPARATUS FOR MODIFYING IMAGE

(71) Applicant: BAE SYSTEMS plc, London (GB)

(72) Inventor: Simon Trythall, Rochester Kent (GB)

(73) Assignee: BAE SYSTEMS plc, London (GB)

(21) Appl. No.: 18/261,002

(22) PCT Filed: Dec. 21, 2021
(86) PCT No.: PCT/GB2021/053397

§ 371 Date: Jul. 11, 2023

(30) Foreign Application Priority Data
Jan. 11, 2021 (EP) 21275001.2
Jan. 11, 2021 (GB) 2100321.5

(51) Int. Cl. G06T 5/00; G06T 5/10; G06T 5/20; G06T 7/20; G06V 10/24

(52) U.S. Cl. CPC G06T 5/003; G06T 5/10; G06T 5/20; G06T 7/20; G06V 10/24

(57) ABSTRACT

A method to modify an image from a night vision camera is disclosed. The method comprises receiving at least one image from a night vision camera; modifying the at least one image, based on motion data from a tracker system and a shutter time of night vision camera, to remove smear from the image; and outputting the modified at least one image.

FIG. 1 to be published with the application.

### BACKGROUND

Night vision cameras may be used in display systems to display an image to a user when light levels are too low for conventional visible light cameras. To maximise the sensitivity of the night vision camera, the shutter time is as long as practical. However, a long shutter time may lead to smear, as the user may move whilst the shutter is open. This reduces image quality and therefore users may miss critical details in the scenes captured by the night vision camera.

### BRIEF DESCRIPTION OF DRAWINGS

FIG. 1 illustrates a method to modify an image according to some examples.

FIG. 2 illustrates a method to align and average two sequential images according to some examples.

FIG. 3 illustrates a method to align and average an image over n sequential images according to some examples.

FIG. 4 illustrates a method to filter an image according to some examples.

FIG. 5a illustrates an image captured by a night vision camera.

FIG. 5b illustrates the image after with simulated motion smear and noise applied.

FIG. 5c illustrates the filtered image.

FIG. 5d illustrates an averaged and filtered image.

FIG. 6 illustrates a method to align, average and filter an image according to some examples.

FIG. 7 illustrates a processing means according to some examples.

### DETAILED DESCRIPTION

Night vision cameras (NVC) may be used when light levels are too low for conventional visible light cameras to display an image to a user with usable detail. In order to increase the amount of light received by the NVC, the shutter time may be maximised. However, this has an effect of inducing smear in the image when there is movement. Smear deteriorates the image and may obscure critical features in the image. This may reduce safety or user effectiveness when the NVC is used as part of a display system, especially in fast moving systems such as in head mounted displays or head up displays in aircraft or vehicles.

A typical approach to reduce smear may be to decrease the shutter time. However, decreasing the shutter time would likely increase the signal to noise ratio (SNR) of the image and in order to compensate for the reduced shutter time integration over a number of images may be required.

In many applications a known tracker system may be included. For example a head worn display comprises a tracker system to track the orientation of the display in its environment. Tracker systems may also be used on drones, where an image is provided to a user. The tracker system may output motion data related to the reference frame of the tracker system, and/or an object tracked by the tracker system. For example, in an example comprising a tracker system used to track a head mounted display on aircraft, the tracker system may track the motion of the aircraft and also the motion of the HWD in the aircraft. Typically, the object comprises the NVC. The motion data may be used to mitigate the effects of the smearing, as the tracker system may track the movement of the NVC.

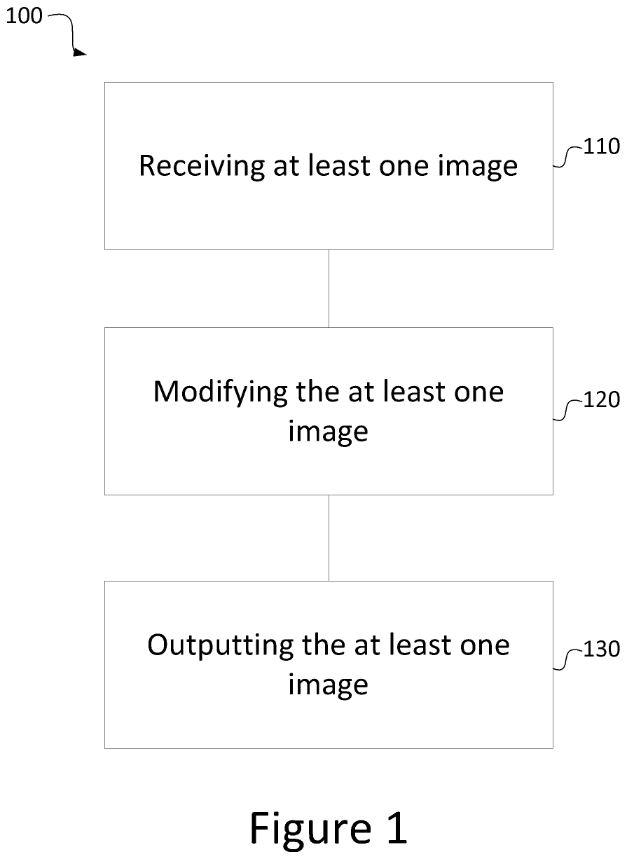

A method to mitigate smear without increasing SNR or decreasing the shutter time is described with relation to FIG. 1, the method is referenced with reference sign 100. A processing means receives at least one image from a NVC 110. At substantially the same time the processing means may receive motion data from a tracker system associated with the NVC. The tracker system may track at least the orientation of the NVC or an object of known relation to the NVC. The tracker system may comprise a system similar to that described in PCT Publication WO 2017/042578, hereby incorporated by reference. Another appropriate tracking system may be used.

At 120 the processing means may modify the received image to remove smear from the image. The modification is based on the knowledge of the motion of the NVC and the shutter time of the NVC.

At 130 the modified image is output for display to a user. This may comprise sending the modified image to the display device. This may also comprise displaying the modified image to the user.

In some examples the image may be processed in substantially real-time such that the image displayed to the user is substantially instantaneous. In applications where the image is displayed to a user on a display in real time, the processing should be carried out on the display or helmet. This avoids extra latency. However, if real time use is not required the image may be processed at a different location to the display.

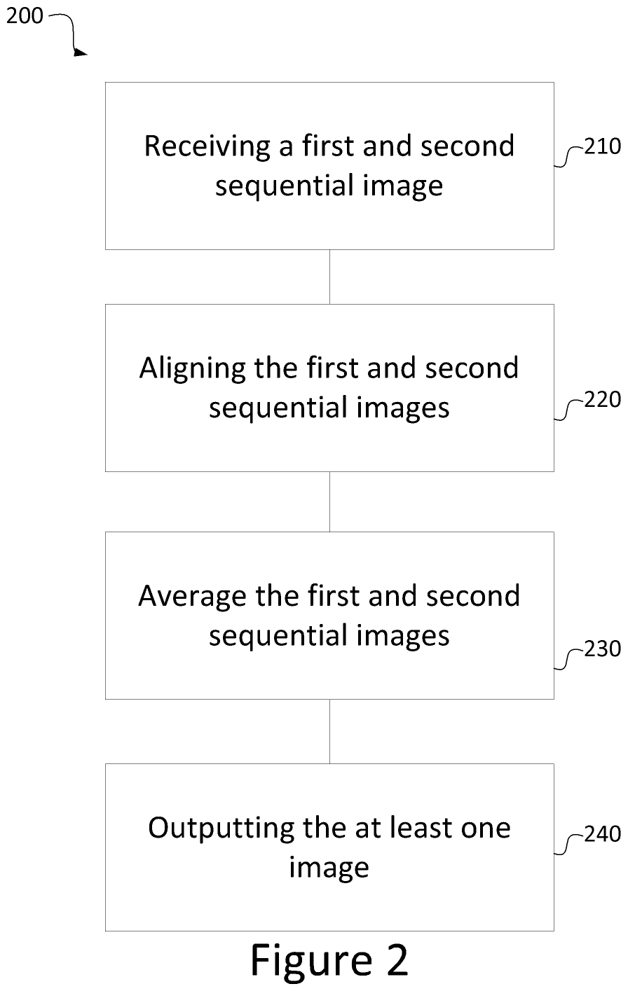

FIG. 2 illustrates a method, 200, in accordance with some examples. At 210 a first sequential image and a second sequential image are received. The images may be received from two consecutive frames of the camera. However, depending upon the frame rate of the camera the frames may not be consecutive. The first sequential image and the second sequential image are received at a known time interval.

At 220 the first sequential image and the second sequential image are aligned based on the known time interval between the images, the shutter speed of the NVC and motion data provided by the tracker system. The motion data may comprise a change in orientation of the NVC which may allow the change in orientation of the images to be determined.

At 230 the aligned images may be averaged. In some examples averaging the images may comprise averaging the pixel intensities. Averaging pixels is also advantageous as it results in a reduction of other types of noise. For example averaging pixels may reduce the appearance of speckle in images.

At 240 the averaged image is output. The image may be output to a processing means, the processing means configured to provide instructions to cause a display the image to a user. In some examples outputting the image may comprise displaying the image to a user on a display.

In some examples the frame rate of the NVC may be equal to the frame rate of a display to display the image to the user. In some examples the frame rate of the NVC may be different from the frame rate of the display.

In some examples the known time interval between the first sequential image and the second sequential image may be less than the shutter speed. In some examples the known time interval between the first sequential image and the second sequential image may be different to the shutter speed.

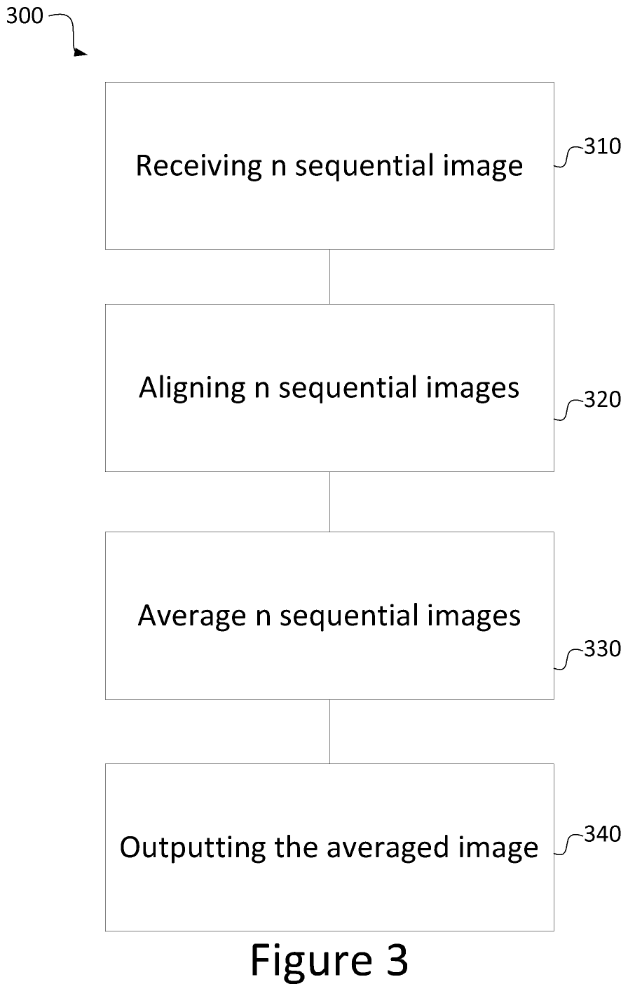

FIG. 3 describes a method substantially similar to the method described with relation to FIG. 2. At 310 n sequential images are received, where n is at least 2. The images may be received from two consecutive frames of the camera. However, depending upon the frame rate of the camera the frames may not be consecutive. The n sequential images are received at a known time interval.

At 320 the n sequential images are aligned based on the known time interval between the images, the shutter speed of the NVC and motion data provided by the tracker system. The motion data may comprise a change in orientation of the NVC which may allow the change in orientation of the images to be determined.

At 330 the aligned n images may be averaged. In some examples averaging the images may comprise averaging the pixel intensities.

At 340 the averaged image is output. The image may be output to a processing means, the processing means configured to provide instructions to cause a display the image to a user. In some examples outputting the image may comprise displaying the image to a user on a display.

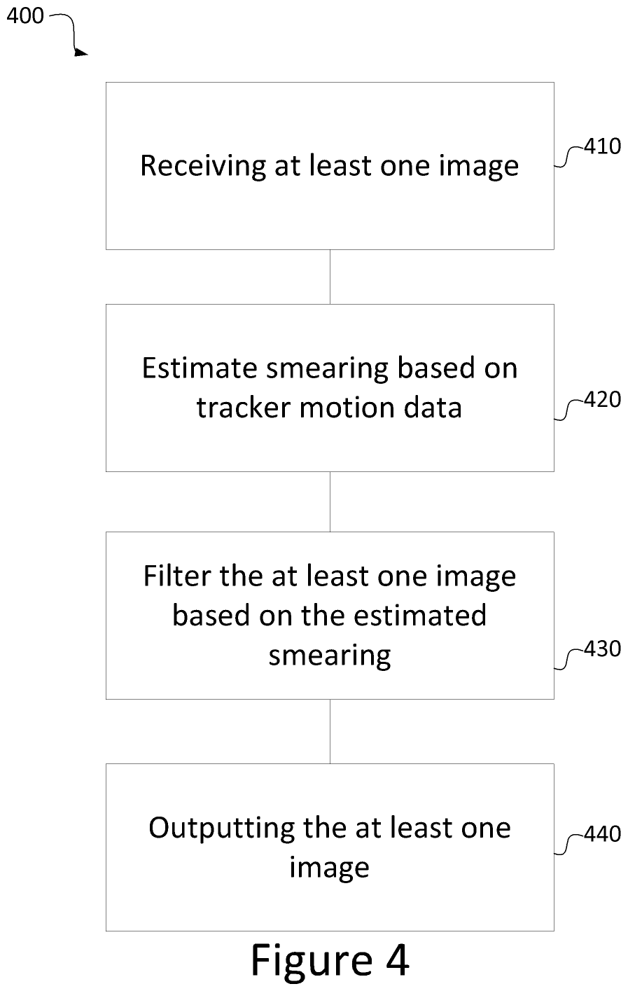

FIG. 4 illustrates a method 400 in accordance with some examples. The method is substantially similar to the method described with reference to FIG. 1. The method may be used independently of the method described with relation to FIGS. 2 and 3, or may be used in combination with the method described with relation to FIGS. 2 and 3.

Method 400 comprises, at 410, receiving an image. The image may be recorded using a NVC.

An estimate of smearing is made at 420 based on motion data from a tracker system. The motion data may comprise a change in orientation of the NVC during the shutter open time. The estimate of smearing may comprise a point spread function (PSF). The PSF is the function which represents the function by which the image was smeared.

The image is filtered, at 430, using a filter based on the estimate of the smearing. The filter may additionally be based on an estimate of noise in the image. The filter may comprise a Wiener filter. The image may be transformed prior to filtering. In some examples the transformation may comprise a discrete Fourier transform. Transforming the image prior to filtering may allow the image to be filtered more efficiently. A Wiener filter may be preferable to an inverse filter, as an inverse filter may amplify noise in the image resulting in a worse image. The Weiner filter reduces the amount of correction based on the level of noise, hence a compromise between fully correcting the image and but not adding too much noise.

At 440 the filtered image is output. The image may be output to a processing means, the processing means configured to provide instructions to cause a display the image to a user. In some examples outputting the image may comprise displaying the image to a user on a display. The image may be output still in the transformed domain and the inverse transform performed at a later point, or may be transformed back into the original domain using an inverse transformation. In some examples the transformation may comprise an inverse Fourier transformation or a discrete inverse Fourier transformation.

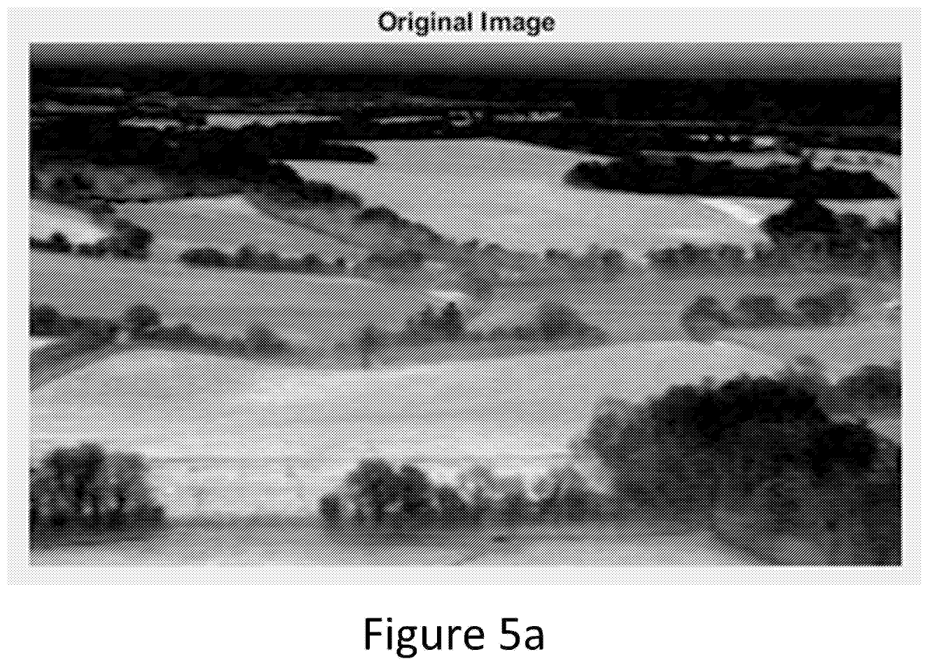

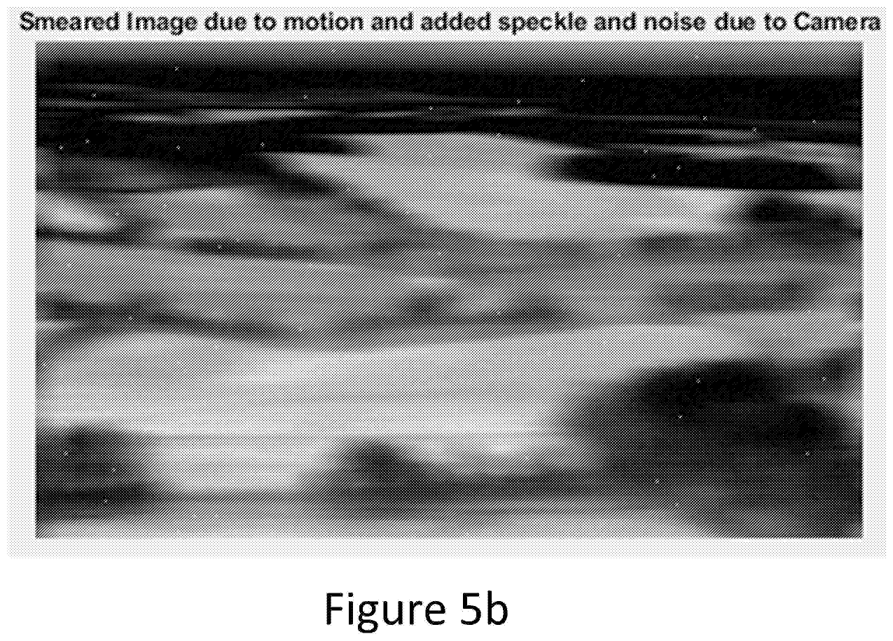

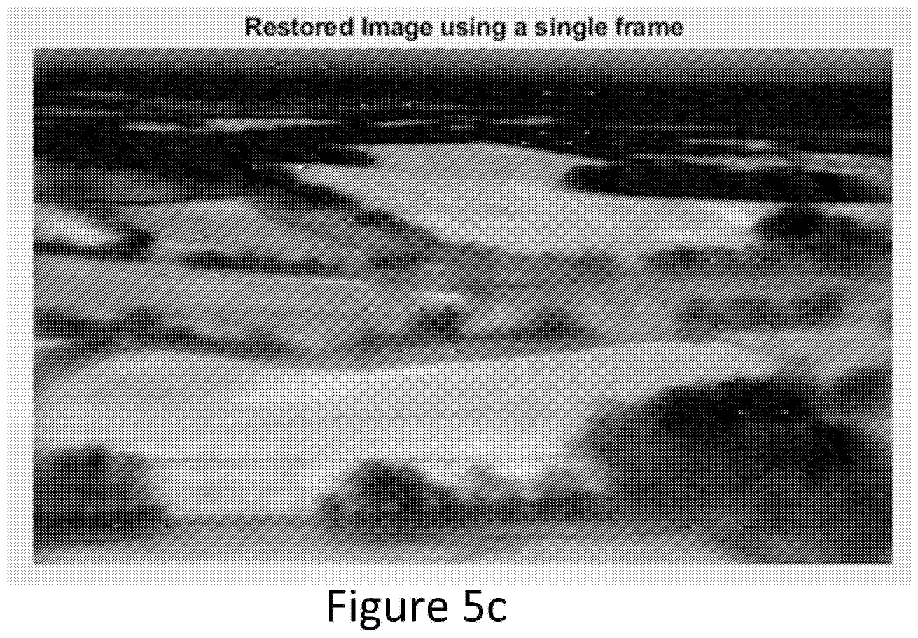

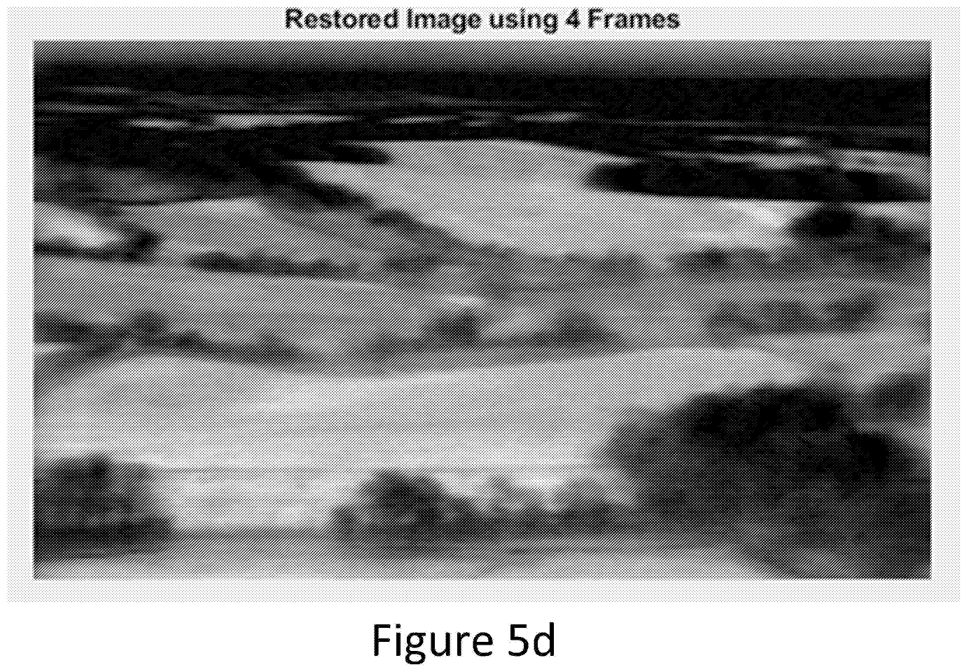

A filtered image using the method 400 is illustrated in FIGS. 5a-c. FIG. 5a represents an image recorded by a night vision camera without any significant smearing. In FIG. 5b the image has had smear and random noise and speckle applied to it to simulate what an user of a NVC may observe when seeing a smeared image. The noise and speckle is independent of motion, and smearing is motion dependent.

FIG. 5c illustrates the image when the image has been filtered using a method substantially as described with reference to FIG. 4. As can be observed in FIG. 5c the smearing is substantially reduced. However, as the noise is independent of motion of the NVC, the noise has been smeared.

The presence of noise may reduce the effectiveness of the filtering process. To reduce the impact of noise the image may be filtered prior to passing the averaged image to the filter. FIG. 5d illustrates an image where the four frames have been aligned and averaged prior to filtering. As can be seen in FIG. 5d the appearance of speckle is reduced compared to FIGS. 5b and 5c, and more detail of the image is viewable.

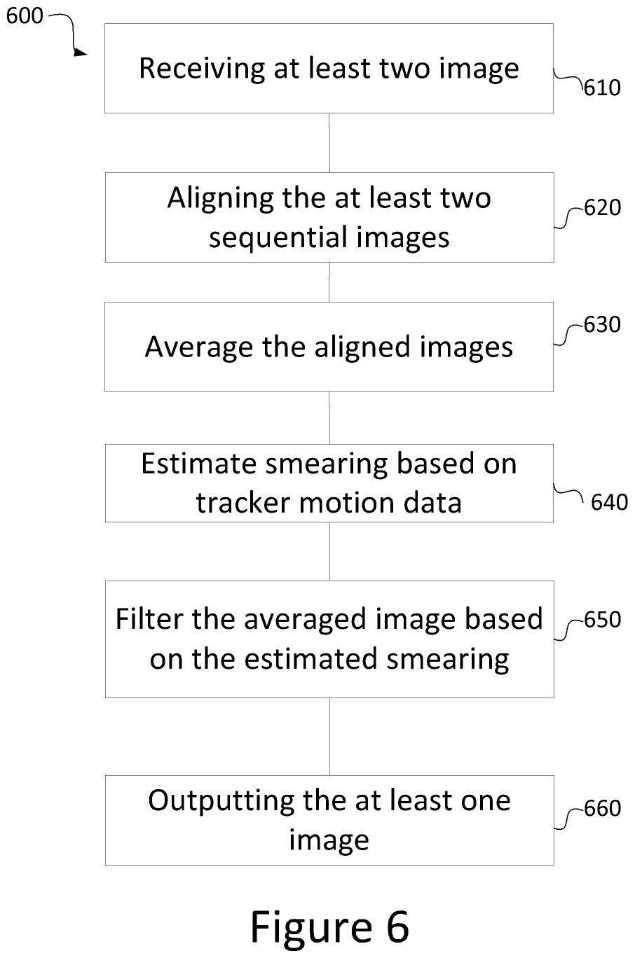

A method to average sequential images and filter the averaged image is illustrated in FIG. 6. The method 600 comprises, at 510, receiving at least two sequential images. The images may be received from two consecutive frames of the camera. However, depending upon the frame rate of the camera the frames may not be consecutive. The at least two sequential images are received at a known time interval.

At 620 the at least two sequential images are aligned based on the known time interval between the images, the shutter speed of the NVC and motion data provided by the tracker system. The motion data may comprise a change in orientation of the NVC which may allow the change in orientation of the images to be determined.

At 630 the aligned images may be averaged. In some examples averaging the images may comprise averaging the pixel intensities.

An estimate of smearing is made at 640 based on motion data from a tracker system. The motion data may comprise a change in orientation. The change may comprise a delta angle value or may comprise an angular rate. The estimate of smearing may comprise a point spread function (PSF). The PSF is the function which represents the function by which the image was smeared.

The image is filtered, at 650, using a filter based on the estimate of the smearing. The filter may additionally be based on an estimate of noise in the image. The filter may comprise a Wiener filter. The image may be transformed prior to filtering. In some examples the transformation may comprise a discrete Fourier transform. Transforming the image prior to filtering may allow the image to be filtered more efficiently.

At 660 the averaged image is output. The image may be output to a processing means, the processing means configured to provide instructions to cause a display the image to a user. In some examples outputting the image may comprise displaying the image to a user on a display. The image may be output still in the transformed domain, or may be transformed back into the original domain. In some examples the transformation may comprise an inverse Fourier transformation.

The Wiener filter may be used to estimate the optimum image as follows:

$$\hat{F} ( u , v ) = ( \frac{1}{H ( u , v )} \frac{\vert H ( u , v ) {\vert}^{2}}{\vert H ( u , v ) {\vert}^{2} + K} ) G ( u , v )$$

where:
G(u,v) is the discrete fourier transform (DFT) of the captured image,
\hat{F}(u, v) is the DFT of the estimated corrected image,
H(u, v) is the DFT of the PSD (power spectral density) causing the smearing,

$$K = \frac{{S}_{η} ( u , v )}{{S}_{f} ( u , v )} ,$$

S_{η}(u, V) is the power spectrum of the noise,
S_{f}(u, v) is the power spectrum of the image (without smear or noise).

K is pre-calculated prior to use of the system, S_{f}(u,v) is estimated based on a typical image and S_{η}(u, v) is calculated based on the known (estimated) noise performance of the camera. Typically K may be adjusted to optimise the trade-off between final image noise and the sharpness of the image. K may also be adjusted to take into account the differing noise levels depending on the electronic gain of the camera. I.e. at lower light levels where the gain of the camera is increased, K is increased to increase the emphasis on smoothing.

The final image is calculated by performing an inverse DFT on \hat{F}(u,v).

To decrease the amount of spatial ringing due to the edge effects of the DFT, the image may be blurred at the edges prior to performing the DFT.

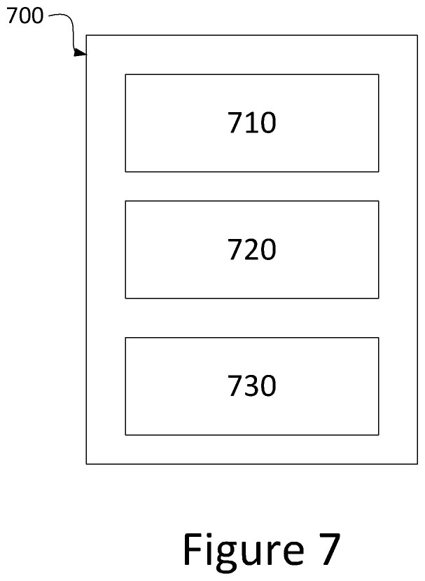

FIG. 7 illustrates a processing means 700 according to some examples. The processing means 700 comprises a first circuitry 710, a second circuitry 720 and a third circuitry 730.

The first circuitry 710 is configured to receive receiving at least one image from a night vision camera.

The second circuitry 720 is configured to modify the at least one image, based on motion data from a tracker system and a shutter time of the night vision camera, to remove smear from the image.

The third circuitry 730 is configured to output the modified at least one image.

The second circuitry 720 may be configured to align at least two sequential images based on motion data from the tracker system, and after aligning the at least two sequential images, averaging pixel intensities over the aligned at least two sequential images.

Aligning the at least two sequential images based on motion data from the tracker system may comprise calculating a change in rotation of the night vision camera between the at least two sequential images.

The second circuitry 720 may be configured to apply a filter to the at least one image, wherein the filter coefficients of the filter are based on motion data from the tracker system.

The second circuitry 720 may be configured to average pixel intensities over the at least two sequential images prior to applying the filter.

In some examples the filter may comprise a Weiner filter.

In some examples the frame rate of night vision camera is higher than a display system frame rate.

In some examples a field of view of the night vision camera is larger than a field of view of a display to display the modified image to a user.

In some examples the second circuitry 720 may be configured to estimate a point spread function associate with the at least one image.

In some examples the second circuitry 720 may be configured to estimate a measure of noise in the image.

In some examples the motion data comprises an orientation of the night vision camera.

Although the above techniques have been described with reference to night vision cameras, the methods are applicable to any type of camera where smearing is caused by motion of the camera whilst the shutter is open and the speed of the motion is comparable to the shutter time of the camera. In some examples the methods described may be applied to a night vision camera on a head mounted display on an aircraft, by leveraging the existing head tracking system. In some examples the methods may also be applied to a camera on a moving platform, such as a drone which comprises tracking software.

It is also understood that a camera may not have a mechanical shutter, and as such shutter speed or time may refer to an electronic shutter the time that the sensors detect light in a frame. The methods are equally applicable to a mechanical or an electronic shutter.

1. A method comprising:
receiving at least one image from a night vision camera;
modifying the at least one image, based on motion data from a tracker system and a shutter time of the night vision camera, to remove smear from the at least one image; and
outputting the modified at least one image.

2. The method according to claim 1, wherein the at least one image comprises at least two sequential images, and modifying the at least one image comprises aligning the at least two sequential images based on the motion data from the tracker system, and after aligning the at least two sequential images, averaging pixel intensities over the aligned at least two sequential images.

3. The method according to claim 2, wherein aligning the at least two sequential images based on the motion data from the tracker system comprises calculating a change in rotation of the night vision camera between the at least two sequential images.

4. The method according to claim 1, wherein modifying the at least one image comprises applying a filter to the at least one image, wherein one or more filter coefficients of the filter are based on the motion data from the tracker system and the shutter time of the night vision camera.

5. The method according to claim 4, wherein the at least one image comprises at least two sequential images, and wherein modifying the at least one image comprises averaging pixel intensities over the at least two sequential images prior to applying the filter.

6. The method according to claim 4, wherein the filter comprises a Weiner filter.

7. The method according to claim 1, wherein a frame rate of the night vision camera is higher than a display system frame rate.

8. The method according to claim 1, wherein a field of view of the night vision camera is larger than a field of view of a display to display the modified at least one image to a user.

9. The method according to claim 1, wherein modifying the at least one image comprises estimating a point spread function associated with the at least one image.

10. The method according to claim 1, wherein modifying the at least one image comprises estimating a measure of noise in the at least one image.

11. The method according claim 1, wherein the motion data comprises an orientation of the night vision camera.

12. The method according to claim 1, comprising applying a Fourier transform to the at least one image prior to modifying the at least one image based on the motion data.

13. The method according to claim 1, comprising applying an inverse Fourier transform to the modified at least one image.

14. A processing system comprising:
a first circuitry configured to receive at least one image from a night vision camera;
a second circuitry configured to modify the at least one image, based on motion data from a tracker system and a shutter time of the night vision camera, to remove smear from the at least one image; and
a third circuitry configured to output the modified at least one image.

15. The processing system according to claim 14, wherein the second circuitry is configured to align at least two sequential images based on the motion data from the tracker system, and after aligning the at least two sequential images, the second circuitry is configured to average pixel intensities over the aligned at least two sequential images.

16. The processing system according to claim 14, wherein the second circuitry is configured to apply a filter to the at least one image, wherein one or more filter coefficients of the filter are based on the motion data from the tracker system.

17. A processing system configured to perform the method of claim 1.

18. One or more non-transitory machine-readable mediums encoded with instructions that when executed by one or more processors causes a process to be carried out, the process comprising:
receiving at least one image from a night vision camera;
modifying the at least one image, based on motion data from a tracker system and a shutter time of the night vision camera, to remove smear from the at least one image; and
outputting the modified at least one image.

19. The method according to claim 12, wherein the Fourier transform is a discrete Fourier transform.

20. The method according to claim 13, wherein the inverse Fourier transform is an inverse discrete Fourier transform.
